(19) United States
(12) Patent Application Publication
(10) Pub. No.: US 2009/0083057 A1
(43) Pub. Date: Mar. 26, 2009

(54) Use Of Commodity Pricing Information In Making Decisions On Purchasing Of Items

(75) Inventors: Rajaram Mohandas Bhakta, Hyderabad (IN); Arun Das, Bhubaneshwar (IN); Siddesh Colvenkar, Salcete (IN)

Correspondence Address: LAW FIRM OF NAREN THAPPETA, C/o Landon-IP Inc.,, 1700 Diagonal Road, Suite 450, Alexandria, VA, 22314, US

(73) Assignee: Oracle International Corporation, Redwood Shores, CA (US)

(21) Appl. No.: 11/935,418

(22) Filed: Nov. 6, 2007

(30) Foreign Application Priority Data
Sep. 24, 2007 (IN) 2148/CHE/2007

(51) Int. Cl. G06Q 99/00; G06F 17/00

(52) U.S. Cl. 705/1

(57) ABSTRACT

A computer implemented approach which simplifies the task of a user in using commodity pricing information in making decisions on purchasing of items. The user is provided a suitable interface using which the constituent commodities and the required respective quantities for each item may be specified. The digital processing system then automatically (without requiring manual entry by the user) retrieves the current prices of the commodities, and provides various types of information which simplifies the purchasing decisions. According to one aspect, alerts are provided when the prices of a commodity does not satisfy pre-specified limits or when the aggregate cost of commodities required for one unit of the item does not satisfy a pre-specified limit. Similarly, information is presented which simplifies hedging decisions and buy or make decisions.

### RELATED APPLICATION

The present application is related to and claims priority from the co-pending India Patent Application entitled, “Use of Commodity Pricing Information in Making Decisions on Purchasing of Items”, Serial Number: 2148/CHE/2007, attorney docket number: ORCL-067/India, Filed: Sep. 24, 2007, Applicant: Oracle International Corporation, naming the same inventors Rajaram Mohandas Bhakta, Arun Das and Siddesh Colvenkar as in the subject patent application, and is incorporated in its entirety herewith.

### BACKGROUND

1. Technical Field

The present disclosure relates to manufacturing environments and more specifically to use of commodity pricing information in making decisions on purchasing of items.

2. Related Art

Commodities generally refer to basic substances such as metals and fuels, which are easily interchangeable with material of the same type in a manufacturing scenario. Commodities are generally used in manufacturing various products, components, etc., (generally referred to as items hereafter) and are widely used by many different parties for manufacturing corresponding items.

The price (the consideration at which a unit of the commodity can be purchased) of a commodity is generally dependant on the supply-demand scenario in a given time duration. Structured markets such as commodity exchanges (e.g., New York Mercantile Exchange) and various other channels are often used for purchasing and selling commodities.

The pricing information of commodities is often of interest for organizations which purchase items at least because the pricing information of commodities affects the cost basis (for the seller).

Various aspects of the present invention simplify the use of such pricing information in purchasing decisions of buyers of items.

### BRIEF DESCRIPTION OF THE DRAWINGS

Example embodiments of the present invention will be described with reference to the accompanying drawings briefly described below.

FIG. 1 is a block diagram illustrating an example scenario in which several aspects of the present invention can be implemented.

FIG. 2 is a block diagram illustrating the details of a digital processing system in which various aspects of the present invention are operative by execution of appropriate software instructions.

FIG. 3 is a flowchart illustrating the manner in which commodity pricing information can be used in making decisions on purchasing, according to an aspect of the present invention.

FIG. 4 is a flowchart illustrating the manner in which commodity pricing information may be used to provide alerts to a user to enable the user to make decisions on purchasing of items according to one embodiment of the present invention.

FIG. 5 is a flowchart illustrating the manner in which commodity pricing information may be used to enable a user to make decisions on increase in price for an item sought by a supplier according to one embodiment of the present invention.

FIG. 6 is a flowchart illustrating the manner in which commodity pricing information may be used for make/buy decisions according to one embodiment of the present invention.

FIG. 7 is a flowchart illustrating the manner in which commodity pricing information may be used for assisting hedging decisions according to one embodiment of the present invention.

FIG. 8 is a screen depicting a user may define the commodities which are used in maintaining item data, in one embodiment.

FIG. 9 depicts the manner in which a user may specify the list of items of inventory sought to be managed, in one embodiment.

FIG. 10 depicts the manner in which a user may specify constituent commodities of an item and the corresponding required quantities of each commodity, in one embodiment.

FIG. 11 depicts the manner in which a user may specify the limit data for commodities and items, in one embodiment.

FIG. 12 depict the manner in which alerts may be presented to a user on the current price of a commodity not satisfying a price limit or an item not satisfying a cost limit, in one embodiment.

FIG. 13 depicts the manner in which the expected demand and projected prices of commodities of interest may be presented to a user to enable the user to take decisions on hedging of commodities, in one embodiment.

In the drawings, like reference numbers generally indicate identical, functionally similar, and/or structurally similar elements. The drawing in which an element first appears is indicated by the leftmost digit(s) in the corresponding reference number.

### DESCRIPTION OF EXAMPLE EMBODIMENTS

1. Overview

An aspect of the present invention facilitates users to make better decisions related to purchase of items based on commodity price information. In an embodiment, the user may provide item data indicating the specific commodities required for each of the items of interest. The system then automatically (i.e., without manual entry of the information) retrieves the current price information for the specified commodities and assists the user in making informed decisions on purchasing. In one embodiment, the system computes the aggregate commodity cost for an item, which can be used by the user to make various decisions of interest.

According to another aspect of the present invention, the system receives limit data indicating the price limit for a commodity. When the current price does not satisfy the price limit (i.e., falls below a lower limit or exceeds an upper limit), the system provides a suitable alert of the user.

According to yet another aspect of the present invention, the system provides alerts to a user when the aggregate commodity cost for an item does not satisfy a corresponding cost limit. The aggregate commodity cost may be computed based on the current prices and the respective quantities of the constituent commodities required for manufacturing the corresponding item.

According to one more aspect of the present invention, the system receives fixed costs associated with each of the items. The system then compares a sum of the aggregate commodity cost and the associated fixed costs with the price quoted by a supplier (for the same item) and the comparison results may be provided to the user. The comparison results may be used by the user in deciding whether to purchase the item from a supplier or manufacture the item.

Yet another aspect of the present invention determines the aggregate requirement for a specific commodity based on the requirements across all items and geographies, and uses the historical price information to assist a user in making decisions on whether/how to hedge (purchase options) for any price fluctuations.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, with other methods, or combining one more aspects/features described herein, etc. In other instances, well-known structures or operations are not shown in detail to avoid obscuring the features of the invention.

2. Example Scenario

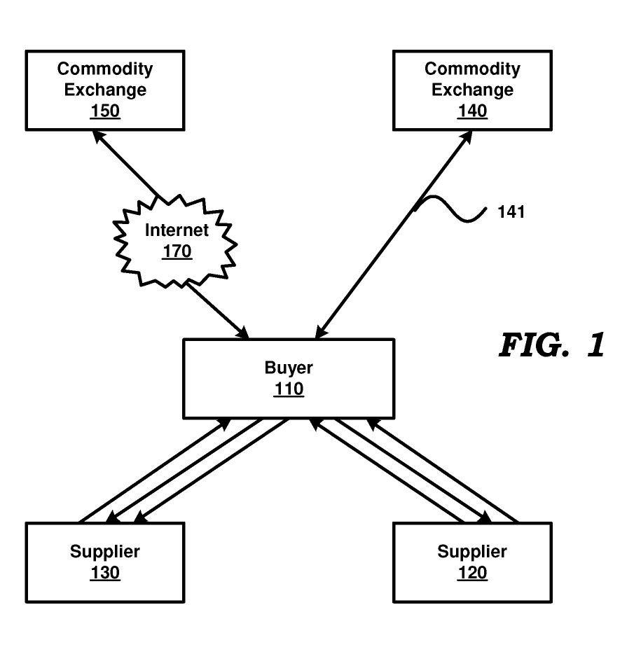

FIG. 1 is a block diagram illustrating an example scenario in which several aspects of the present invention can be implemented. The block diagram is shown containing buyer 110, item suppliers 120 and 130, and commodity exchanges 140 and 150.

Merely for illustration, only representative number/type of organizations and transactions are shown in the Figure. Many scenarios often contain many more/less organizations and transactions, both in number and type, depending on the purpose for which the scenario is designed. For example, though two suppliers are shown in FIG. 1, there may be only one supplier or there may be a number of suppliers. As another example, though two commodity exchanges are shown, there could be only one commodity exchange or there could be a number of commodity exchanges. Each block of FIG. 1 is described below in further detail.

Internet 170 provides connectivity between commodity exchange 150 and buyer 110. Internet 170 may be implemented using protocols such as Internet Protocol (IP) well known in the relevant arts. Similarly, path 141 (e.g., implemented as a dial-up or a leased connection) provides connectivity between commodity exchange 140 and buyer 110 (used synonymously with the corresponding organization/facilities). In general, Internet 170 and path 141 represent communication paths using which a system at buyer 110 automatically (without requiring a human being to enter the price data) retrieves the price information for commodities.

Suppliers 120 and 130 receive orders for corresponding items from buyer 110, manufacture the items using different commodities, and supplies the items to buyer 110 according to corresponding orders. Each order may specify one or more items (and associated quantities) and the price (the terms of the transactions, in general) for the items. The terms (including price, time/mode of delivery, etc.) may be mutually agreed between the suppliers and the buyers.

Commodity exchanges 140 and 150 represent organizations which permit trading of various commodities by various sellers and buyers. At least due to such trading, the price of each commodity can vary over time. Commodity exchanges 140 and 150 may provide real time pricing information to interested parties.

Buyer 110 represents an organization, which purchases the items manufactured by suppliers 120 and 130. Buyer 110 may have the optional ability to manufacture some of the items as well. Buyer 110 is shown connected to commodity exchange 140 over communication path 141 (for example a leased line) and to commodity exchange 150 over internet 170.

In response a request from buyer 110, suppliers 120 and/or 130 may provide quotes for the required items to buyer 110. Buyer and the selected suppliers (120 and/or 130) may arrive at an agreed price for the items to be supplied and the buyer may place orders on suppliers 120 and/or 130 for the items at the mutually agreed price. At a later date, due to considerations described below, buyer 110 and/or suppliers 120/130 may request for renegotiations of the price of the items to be supplied to buyer 110.

An aspect of the present invention enables a manufacturing organization (such as buyer 110) to use commodity pricing information available from organizations (such as commodity exchanges 140 and 150) in making decisions on purchasing such as negotiation or renegotiation of prices, make an item or buy it from suppliers (such as supplier 120/130), etc.

Such features can be implemented in various embodiments (as one or more systems) as a desired combination of one or more of hardware, software and firmware. The description is continued with respect to an embodiment in which various features are operative when software instructions are executed in a digital processing system.

3. Digital Processing System

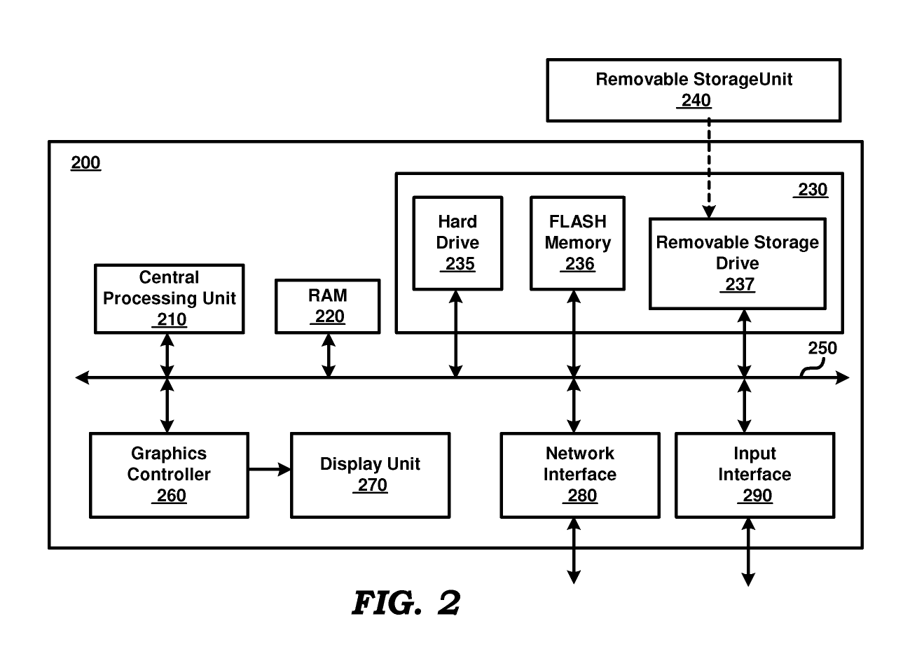

FIG. 2 is a block diagram illustrating the details of digital processing system 200 in which various aspects of the present invention are operative by execution of appropriate software instructions. Though shown as a single unit merely for illustration, the system may be implemented as multiple discrete (independent) units cooperatively communicating, for example, over a network.

Digital processing system 200 may contain one or more processors (such as a central processing unit (CPU) 210), random access memory (RAM) 220, secondary memory 230, graphics controller 260, display unit 270, network interface 280, and input interface 290. All the components except display unit 270 may communicate with each other over communication path 250, which may contain several buses as is well known in the relevant arts. The components of FIG. 2 are described below in further detail.

CPU 210 may execute instructions stored in RAM 220 to provide several features of the present invention. CPU 210 may contain multiple processing units, with each processing unit potentially being designed for a specific task. Alternatively, CPU 210 may contain only a single general-purpose processing unit. RAM 220 may receive instructions from secondary memory 230 using communication path 250.

Graphics controller 250 generates display signals (e.g., in RGB format) to display unit 270 based on data/instructions received from CPU 210. Display unit 270 contains a display screen to display the images defined by the display signals. Input interface 290 may correspond to a keyboard and a pointing device (e.g., touch-pad, mouse etc.). Network interface 280 provides connectivity to a network (e.g., using Internet Protocol), and may be used to communicate with other external systems (e.g., those belonging to supplier 120/130, commodity exchange 140/150 etc).

Secondary memory 230 may contain hard drive 235, flash memory 236, and removable storage drive 237. Secondary memory 230 may store the data and software instructions, which enable digital processing system 200 to provide several features in accordance with the present invention.

Some or all of the data and instructions may be provided on removable storage unit 240, and the data and instructions may be read and provided by removable storage drive 237 to CPU 210. Floppy drive, magnetic tape drive, CD-ROM drive, DVD Drive, Flash memory, removable memory chip (PCMCIA Card, EPROM) are examples of such removable storage drive 237.

Removable storage unit 240 may be implemented using medium and storage format compatible with removable storage drive 237 such that removable storage drive 237 can read the data and instructions. Thus, removable storage unit 240 includes a computer readable storage medium having stored therein computer software and/or data. However, the computer (or machine, in general) readable storage medium can be in other forms (e.g., non-removable, random access, etc.).

In this document, the term “computer program product” is used to generally refer to removable storage unit 240 or hard disk installed in hard drive 235. These computer program products are means for providing software to digital processing system 200 and control the operation thereof. CPU 210 may retrieve the software instructions, and execute the instructions to provide various features of the present invention described below.

4. Using Commodity Pricing Information

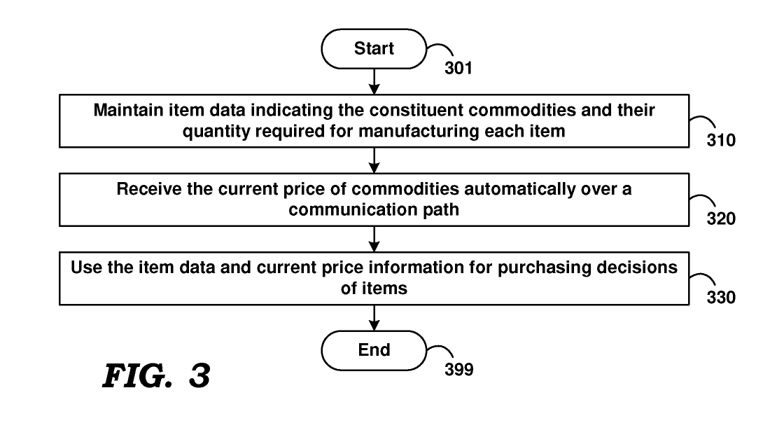

FIG. 3 is a flowchart illustrating the manner in which commodity pricing information may be used in making decisions on purchasing of items according to an aspect of the present invention. The flowchart is described with respect to FIGS. 1 and 2 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 301, in which control immediately passes to step 310.

In step 310, CPU 210 maintains item data indicating the constituent commodities and the respective quantities required for manufacturing each item. For example, if manufacturing 100 units of an item (e.g., metal doors) requires 150 Kilograms of iron and 20 liters of petrol, the corresponding information for the item may be stored as item data. Similar information may be stored for each of the other items of interest. The item data may be stored in secondary memory 230 or may be received through network interface 280 from an external source (for example a database server, not shown).

In step 320, CPU 210 receives the current price of commodities (specified in the item data) automatically (i.e., without manual entry of the information by users using system 200) over a communication path. The current price may correspond to the instantaneous price at the present time instance or be a known price in a short duration in the past (e.g., the previous day closing price).

The current price of commodities may be received from commodity exchange 140 over path 141 or commodity exchange 150 over internet 170 (by network interface 280). The current price of commodities may also be received from other sources such as providers of commodity price information (for example, financial news networks). In general, CPU 210 interfaces with another system to receive the current price information for the commodities. The data may be received according to various conventions such as XML data and used for further processing.

In step 330, the item data and current price information are used for purchasing decisions. For example, CPU 210 may compute the aggregate commodity cost of an item from the item data (step 310) and the current price information received automatically (step 320). The aggregate commodity cost of an item represents the sum total of the cost of each constituent commodity (for the quantity required to manufacture the item) used to manufacture the item. The aggregate cost so computed may be presented to a user to enable the user to make purchasing decisions related to the item. The flow chart ends in step 399.

Thus by using a digital processing system implemented according to flow chart described above, a user may use commodity pricing information to make decisions related to an item. As the price information is retrieved automatically, the ease of use of the system is enhanced. Further, as the current prices (i.e., price around the time point of reception of the data) are retrieved, decisions can be based on complete up-to-date information.

The digital processing system may be implemented to enable a user to use the commodity pricing information in different ways. The description is continued with an example approach to enabling a user to use commodity pricing information.

5. Generating Alerts Based on Commodity Pricing Information

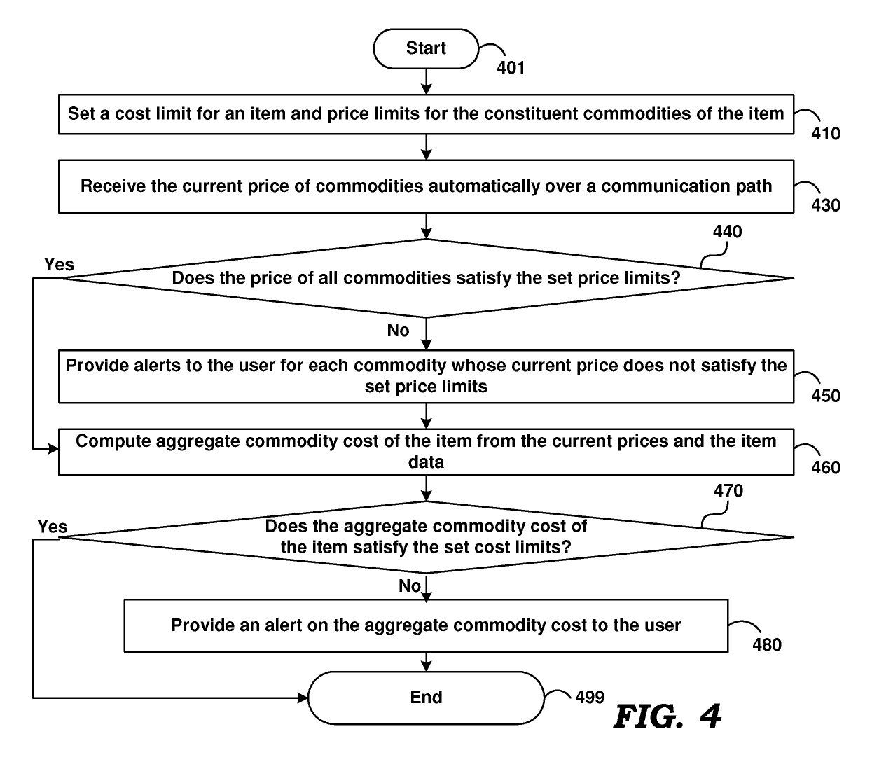

FIG. 4 is a flowchart illustrating the manner in which commodity pricing information may be used to provide alerts to a user to enable the user to make decisions on purchasing of items according to one embodiment of the present invention. The flowchart is described with respect to FIGS. 1-3 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 401, in which control immediately passes to step 410. The description is continued assuming that the items and the constituent commodities are already defined, for example, as described above with respect to step 310.

In step 410, CPU 210 may enable a user to set a cost limit for an item and price limits for the constituent commodities of an item. As an illustration, a price limit may specify an upper price limit and a lower price limit for the price of each constituent commodity of an item (for the aggregate commodity cost of the item). Similar limits may be specified for the cost limits of each item.

The price (or cost) limits may be specified as a percentage (of the price of the respective commodity or the aggregate commodity cost of the item on a specified date, for example, the date on which an order for the item was placed, referred to as the base price) or in terms of value or other ways well known in the relevant arts. A user may provide the price limits through a suitable user interface or using external sources such as a database server (not shown).

In step 430, CPU 210 receives the current price of commodities automatically over a communication path. This step may be performed similar to step 320 above.

In step 440, CPU 210 checks whether the price of all commodities satisfies the set price limits. CPU 210 may compare the current price of each constituent commodity of an item with any upper price limit and lower price limit set in step 410. If the current price of at least one constituent commodity of an item has moved above or below the set price limits, the price for that commodity/those commodities does not satisfy the set price limits and processing continues to step 450. Otherwise, control passes to step 460.

In step 450, CPU 210 provides alerts to the user for each commodity whose current price does not satisfy the set price limits. The alerts may be presented to the user in various ways, such as corresponding information on display screens, emails, SMS (short message service), etc., well known in the relevant arts.

In step 460, CPU 210 computes aggregate commodity cost of the item from the current prices and the item data. The aggregate commodity cost may be computed in a manner similar to that described in step 330.

In step 470, CPU 210 checks whether the current aggregate commodity cost of the item satisfy the set cost limits. CPU 210 may compare the current aggregate commodity cost of the item with the upper cost limit and the lower cost limit for the item set in step 410. If the current aggregate commodity cost of the item does not satisfy the set cost limits, processing continues to step 480. Otherwise, control passes to step 499, where the flow chart ends.

In step 480, CPU 210 provides an alert with the information on the aggregate commodity cost to the user. The alert may be provided in a manner similar to the alert for commodities, described in step 450. The flow chart ends in step 499.

The user may use the alert (either for an item and/or one or more of its constituent commodities) to make decisions on purchasing. For example, if a user, on receiving an alert, finds that the current aggregate commodity cost has moved below the set lower cost limit, the user may take a decision to initiate a price renegotiation with the item's supplier(s) (for example supplier 120 and supplier 130), to reduce the price of the item.

Similarly, a supplier (for example supplier 120 and/or supplier 130) may ask buyer 110 for an increase in the price of an item to be supplied. The supplier(s) may quote increase in the price of constituent commodities of the item as one of the justifications for the increase in price sought for the item.

The description is continued with the manner in which buyer 110 may use commodity pricing information in making decisions on increase in the price of an item to be supplied, in such a scenario.

6. Deciding Price Revision for Suppliers Based on Commodity Pricing Information

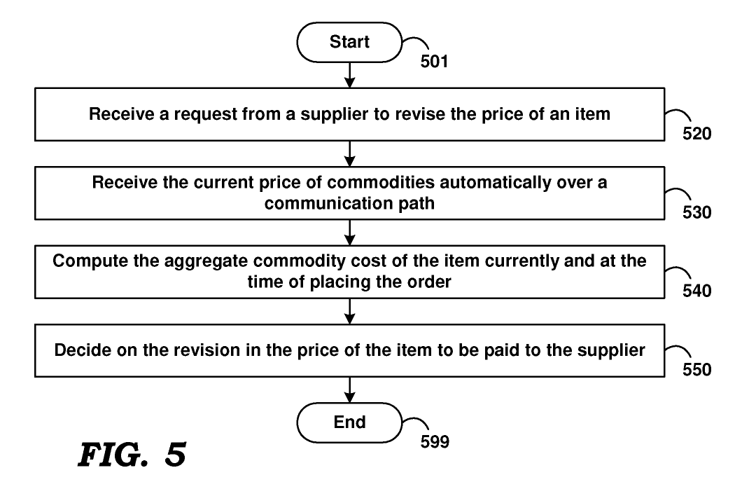

FIG. 5 is a flowchart illustrating the manner in which commodity pricing information may be used to enable a user to make decisions on increase in price for an item sought by a supplier according to one embodiment of the present invention. The flowchart is described with respect to FIGS. 1-4 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 501, in which control immediately passes to step 520.

In step 520, a request is received from a supplier to revise the price of an item. A supplier may request to revise the price of an item due to increase in the price of the constituent commodities (and/or other reasons such as increase in labor costs, transportation costs etc.).

In step 530, CPU 210 receives the current price of commodities automatically over a communication path. This step may be performed similar to step 320 above.

In step 540, CPU 210 computes the aggregate commodity cost of the item currently and at the time of placing the purchase order (PO). The aggregate commodity cost of the item currently may be computed as described in step 330. The aggregate commodity cost of the item at the time of placing the order may be computed using historical costs of the constituent commodities (on the day of placing the order). The historical costs may be retrieved from secondary memory 230, made available from a database server (not shown) over a network, received from commodity exchanges 140/150, received from providers of historical commodity price information such as financial news networks, etc.

In step 550, decision is made on the revision in the price of the item to be paid to the supplier. For example, buyer 110 may decide not to revise the price of the item, if the increase in aggregate commodity cost of the item currently over aggregate commodity cost of the item at the time of placing the order is less than a predetermined percentage (or value). Otherwise, buyer 110 may decide to revise the price of the item and may use the aggregate commodity costs to decide the quantum of increase. For example, buyer 110 may decide to increase the price of the item in the same proportion as the increase in the aggregate commodity cost from the time of placing the order to the current. The flowchart ends in step 599.

Buyer 110 is enabled in making the decision regarding the revision in price of the item to be paid to the user by providing the aggregate commodity cost of the item currently and aggregate commodity cost of the item at the time of placing the order, as described above. Aggregate commodity cost of an item may also be used for make/buy decisions, as described below.

7. Make/Buy Decisions

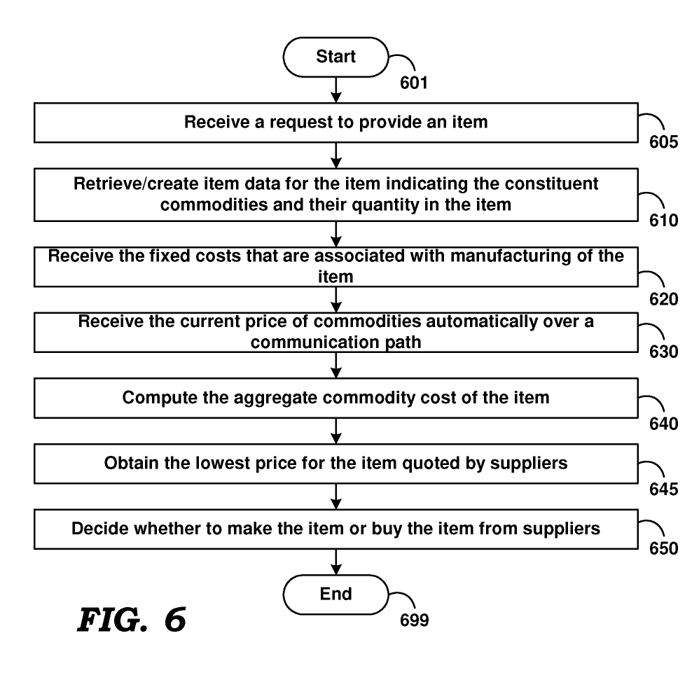

FIG. 6 is a flowchart illustrating the manner in which commodity pricing information may be used for make/buy decisions according to one embodiment of the present invention. The flowchart is described with respect to FIGS. 1-5 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 601, in which control immediately passes to step 605.

In step 605, a request is received to provide an item. The item may be a new item, or an existing item, which is already being procured/manufactured. New items may be required for new products or modifications/improvements to an existing product. An existing item may be required for additional production for which additional quantity of item may be needed.

In step 610, CPU 210 retrieves/create item data for the item indicating the constituent commodities and their quantity in the item. If the item is a new item, the item data may be created through a suitable user interface and saved in secondary memory 230 or in a database server (not shown) etc. If the item is an existing item, the user may search for the item (in the storage where item data is stored) and retrieve the item data for the item.

In step 620, CPU 210 receives the fixed costs that are associated with manufacturing of the item. In this document, fixed costs refers to all costs (for example costs due to fixed installations such as buildings, plants and machinery, depreciation, finance costs, labor costs, etc.) involved in the manufacture of an item other than the aggregate commodity cost. A user may provide the fixed costs through a suitable user interface or using external sources such as a database server (not shown). Alternatively, the fixed costs can be computed from information maintained in other sources.

In step 630, CPU 210 receives the current price of commodities automatically over a communication path. This step may be performed similar to step 320 above.

In step 640, CPU 210 computes the aggregate commodity cost of the item. This step may be performed similar to step 330 above.

In step 645, CPU 210 obtains the lowest price for the item quoted by suppliers. The price may be obtained from suppliers (for example supplier 120/130). Suppliers may also provide prices which are valid for a specified term, in which case the price may be retrieved from storage such as secondary memory 230 or a database server (not shown) where currently valid prices are stored. CPU 210 may then determine the lowest price from the available price quotes.

In step 650, it is decided whether to make the item or buy it from suppliers. For making the decision, CPU 210 computes the sum of the fixed cost (received in step 620) and the aggregate commodity cost of the item (computed in step 640) to get the cost of manufacturing the item by buyer 110 and this sum is compared with the lowest price quoted by supplier(s), as determined in step 645. If the cost of manufacture is lesser, a decision to make (manufacture the item) may be made. Otherwise, a decision to buy it from the supplier(s) quoting the lowest price may be made. The flowchart ends in step 699.

Thus, commodity pricing information may be used for make/buy decisions. The description is continued with one more example of use of commodity pricing information.

8. Assisting Hedging Decisions

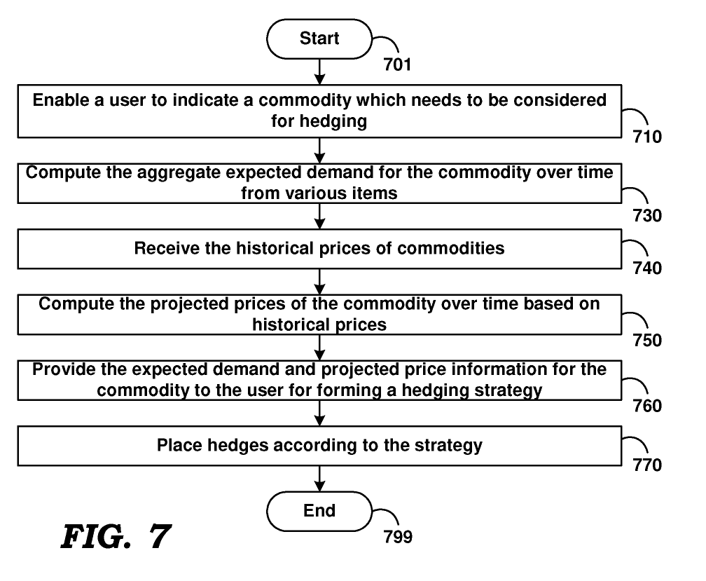

FIG. 7 is a flowchart illustrating the manner in which commodity pricing information may be used for assisting hedging decisions according to one embodiment of the present invention. The flowchart is described with respect to FIGS. 1-6 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 701, in which control immediately passes to step 710.

In step 710, CPU 210 enables a user to indicate a commodity which needs to be considered for hedging. A user may indicate a commodity which needs to be hedged through a suitable user interface.

Hedging, in this document, refers to commodity transactions done to mitigate the effects of unfavorable commodity price movements on cost of manufacturing items. For example, if tires (an example item) are being procured by buyer 110 (for example, an automobile manufacturer) on a regular basis, any upward movement of rubber prices (an example of unfavorable commodity price movement) would adversely affect the cost of tires. An example hedging strategy may be to buy rubber in the futures market, so that buyer 110 is not affected by any upward movement of rubber prices, for the quantity bought in the futures market. There may be many hedging strategies such as options, futures, combination of options and futures, etc., well known in the relevant arts.

A user may decide to hedge for all commodities needed for manufacture of various items, or may decide to hedge only some commodities, which may be selected according to different criteria, for example, commodities showing high volatility in prices, commodities which have to be imported, commodities derived from petroleum, etc.

In step 730, CPU 210 computes the aggregate expected demand for the commodity over time from various items. The aggregate expected demand for the commodity may be computed from the item data for items and expected demand (quantity) for the respective items over the time period under consideration. The item data for items may be defined, for example, as described above with respect to step 310. The expected demand may be computed from existing orders for items, orders being negotiated for items, historical order data for items, etc. which may be retrieved from secondary memory 230, received over a network, etc.

In step 740, CPU 210 receives the historical prices of commodities. The historical prices of commodities may be received from commodity exchange 140 over path 141 or commodity exchange 150 over internet 170. The historical prices of commodities may be also received from other sources such as providers of commodity price information (for example, financial news networks).

In step 750, CPU 210 computes the projected prices of the commodity over time based on historical prices. The projected prices may be computed using formulae and price models well known in the relevant arts.

In step 760, CPU 210 provides the expected demand and projected price information for the commodity to the user for forming a hedging strategy. The information may be provided in the form of tables, graphs, etc. well known in the relevant arts. The expected demand and projected price information provides the user with information about the exposure in the commodity. The user may also receive other information about the commodity such as news, analyst views, etc. from various sources of such information (for example, financial news networks). The user may then form a hedging strategy for the commodity, using different models and approaches, well known in the relevant arts.

In step 770, hedges are placed according to the strategy. Hedges may be placed by placing orders for futures, options, combinations of futures and options, etc. well known in the relevant arts, through organizations which permit hedging (through futures, options, combinations of futures and options, etc) in the commodity, such as commodity exchanges 140 and 150.

The description is continued with respect to an example user interface by which at least some of the features described above with respect to the flowcharts, may be implemented.

9. Example User Experience—Defining Commodities

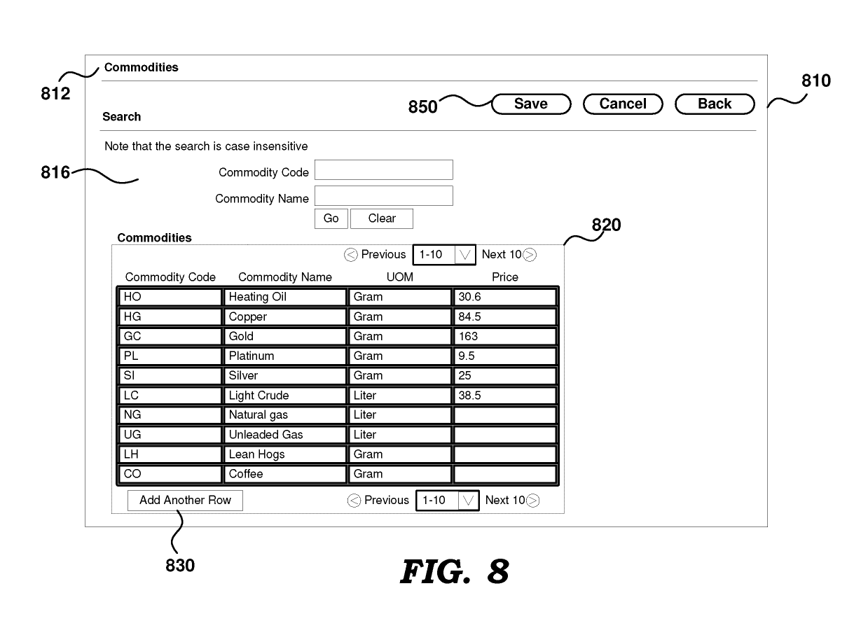

FIG. 8 depicts the manner in which a user may define the commodities which are used in maintaining item data (step 310), in one embodiment. The display there represents a web page displayed by a web browser software on display unit 270, and a user may provide inputs (described below) using input interface 290.

Display area 810 may be viewed as containing multiple fields with corresponding labels provided by CPU 210 (according to the executed software instructions). Text 812 (labeled “commodities”) indicates that commodities are being defined with this screen. Table 820 contains multiple rows, with each row specifying the code, name, unit of measure (UOM) and current price for each unit for the corresponding commodity. It may be appreciated that the current price represents the price retrieved in real-time from an external system, in one embodiment.

The user may add more commodities of interest (830) and save (850) the final list in the table, as shown. The user may search for specific commodities of interest using display portion 816.

10. Example User Experience—Specifying Items

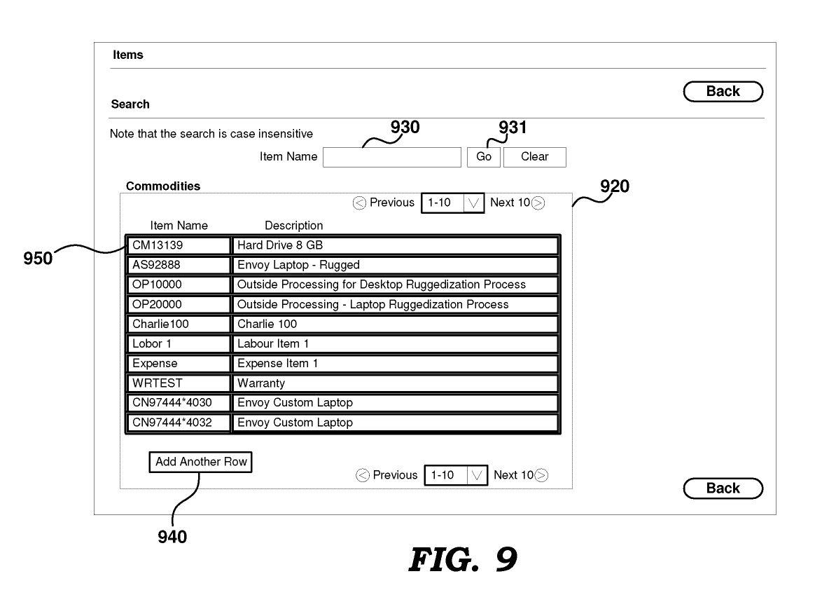

FIG. 9 depicts the manner in which a user may specify the list of items of inventory sought to be managed using system 200, in one embodiment. Table 920 depicts multiple rows, with each row depicting the corresponding list of items of interest entered by a user. The user may search for an item by entering the item name (930) and clicking button “Go” (931).

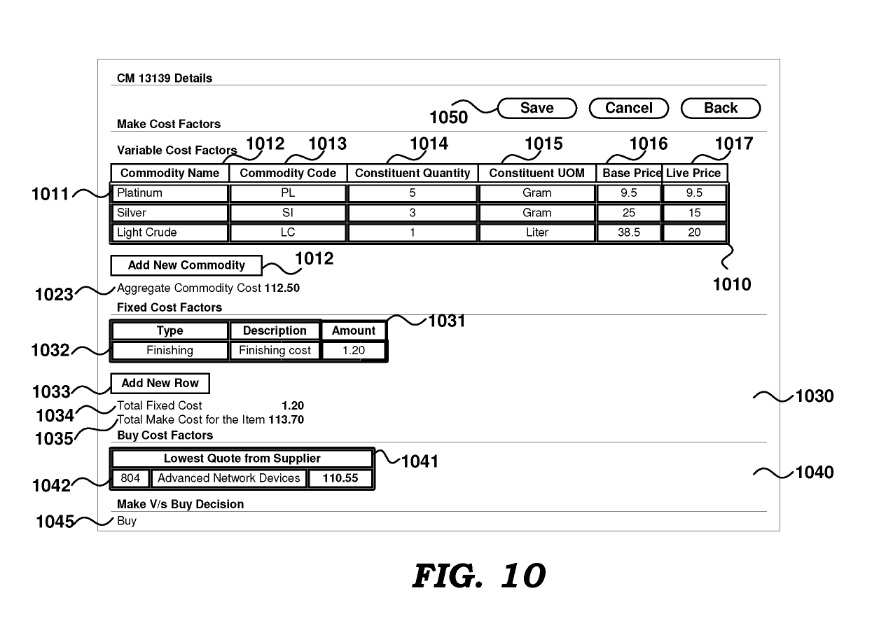

The user may also add (940) more items as desired. The user may select an item (950) whose constituent commodities and their quantity required for manufacturing the item are to be specified. On selecting an item (950), the user may be presented with a screen described below (FIG. 10) and the user may provide inputs using input interface 290.

11. Example User Experience—Specifying Constituent Commodities of an Item

FIG. 10 depicts the manner in which a user may specify constituent commodities of an item and the corresponding required quantities of each commodity (310). The user is shown working with item ‘CM 13139’, also present in FIG. 9. Table 1010 contains multiple rows and columns (1012-1017), with each row depicting information related to a constituent commodity. Thus, row 1011 indicates that a commodity of name (1012) ‘Platinum’, having a code (1013) “PL”, and a quantity (1014) of 5 grams (UOM 1015) are required.

The base price (1016), representing the price of the commodity when the item was ordered, is shown as 9.5 dollars. Live price (1017) is also shown as 9.5 dollars, indicating that the price has not changed since the item was ordered. The user may add more constituent commodity information (1012) and save the information (1050) in the table.

It may be appreciated that the information in columns 1012 through 1015 may be based on user inputs (potentially in other screens, as described above), while the current/live price is retrieved automatically from various external sources and displayed in column 1017. Live price (1017) may represent the last retrieved price of the corresponding commodity. Base price (1016) may be manually entered at the time the terms for purchase of the items are agreed between buyer 110 and supplier 120/130.

Text 1023 (labeled “Aggregate Commodity Cost”) displays the aggregate commodity cost for the item which is shown as 112.50 dollars. The aggregate commodity cost of the item may be computed by CPU 210 from the item data and current price of the respective commodity (Table 1010) as described above in step 330.

Display area 1030 shows Table 1031 containing multiple rows and columns, with each row depicting Type, Description and Amount of Fixed costs associated with the item (‘CM 13139’ in this example) whose item data is displayed in Table 1010. Row 1032 shows the Finishing Cost of 1.20 dollars associated with item CM 13139. A user may add fixed costs (620) (1033) and save the data (1050). Text 1034 displays the total fixed cost (1.20 dollars in this example).

Text 1035 displays the total make cost (the total cost to buyer 110 of manufacturing item CM 13139 which is the sum of the aggregate commodity cost 1023 and the total fixed cost 1034, as described above in step 650).

Display area 1040 displays table 1041 containing multiple rows and columns, with each row depicting the lowest quote for the item (CM 13139) received from suppliers (such as supplier 120/130). Thus row 1042 shows that the lowest quote for item CM 13139 was received from Advanced Network Devices for 110.55 dollars per unit. The lowest quote may be obtained as described in step 645.

Text 1045 displays the result of the decision (650) whether to make the item or buy it from suppliers providing the lowest quote. In this example, as the total make cost (113.70 dollars) is more than the lowest quote from suppliers (110.55 dollars), CPU 210 determines that the decision is to “Buy” the item, and displays the decision as shown in 1045.

12. Example User Experience—Specifying Limit Data

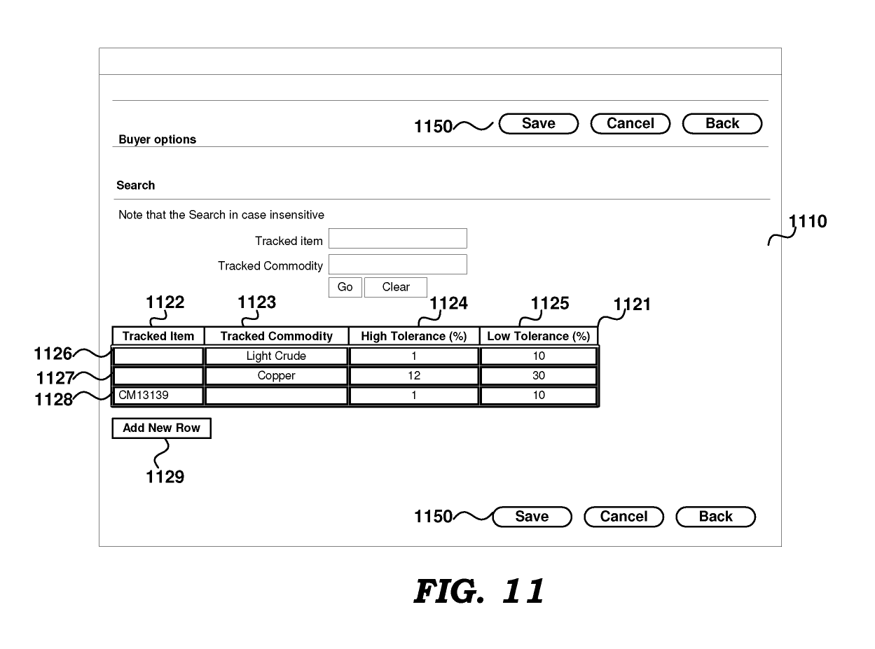

FIG. 11 depicts the manner in which a user may specify the limit data for commodities and items, in one embodiment. Table 1121 contains multiple rows (1126-1128) and columns (1122-1125), with each row depicting information related to price limits of a constituent commodity or cost limits of an item, set in step 410. Thus, row 1126 indicates that a commodity of name (1123) ‘Light Crude’ has a high tolerance 1124 (upper price limit over the base price when the item is ordered) of 1 percent and low tolerance 1125 (lower price limit over the base price when the item is ordered) of 10%. Row 1128 indicates that item CM 13139 (1122) has a high tolerance 1124 (upper cost limit) of 1 percent and low tolerance 1125 (lower cost limit) of 10%.

A user may search for specific commodities and/or items using display area 1110. The user may add more commodities/items of interest (1129) and save (1150) the table, as shown. The information in columns 1124-1125 may be input by a user using input interface 290 and may be used in screens described below.

13. Example User Experience—Displaying Alerts to a User

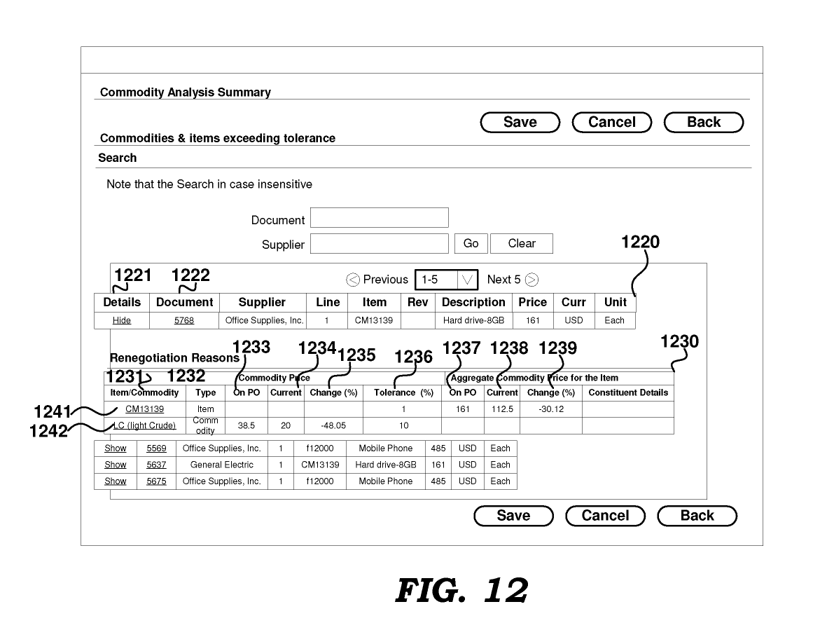

FIG. 12 depicts the manner in which alerts may be presented to a user on the current price of a commodity not satisfying a price limit or an item not satisfying a cost limit, in one embodiment. The user is presented alerts of a commodity not satisfying a price limit or an item not satisfying a cost limit in the form of table 1220. Table 1220 contains multiple rows and columns, with each row depicting information pertaining to an order (for which an alert is being generated).

Each row is shown identified by document (1222), which is a unique identifier for the specific order placed by a user. A user may get the details of the constituent commodities of an item or an item not satisfying the limits (set in FIG. 12) by clicking on “Details” (1221). On clicking on “Details” (1221) for a document, the user is presented a table 1230 containing multiple rows and columns (1231-1239), described in further detail below.

Each row depicts information related to an item or the constituent commodities of the item, which do not satisfy the price limits. Thus row 1241 indicates that an Item/Commodity (1231) named CM13139 (also present in FIGS. 9-11) of Type (1232) Item with a (violated or not satisifed) Tolerance (1236) 1% (which may be set by a user as shown in FIG. 11 and described in step 410 above) and aggregate commodity price on PO (Purchase Order, 1237) of 161 dollars. The aggregate commodity price on PO (1237) may be computed as described in step 540 above. The current aggregate commodity price (1238) is shown as 112.5 dollars (shown in FIG. 10 also), which may be computed as described above in step 330.

CPU 210 checks whether the current aggregate commodity cost for the item satisfies the set cost limits, as described in step 470. The current aggregate commodity price shows a change (1239) of −30.12% from the aggregate commodity price on PO (1237), thus not satisfying the cost limit (1236) of 1% set for the item and therefore an alert has been generated for the item.

Row 1242 indicates a commodity (1231) Light Crude, of Type (1232) Commodity, (a constituent commodity of item CM 13139, shown in FIG. 10), is shown having a commodity price on PO (1233) of 38.5 dollars and current (1234) commodity price of 20 dollars. The price on PO may be obtained as described in step 540 above (historical prices) and the current commodity prices may be received automatically over a communication path as described in step 320 above. As the current (1244) commodity price of 20 dollars is a change (1245) of −48.05% from the commodity price on PO (1233) of 38.5 dollars, which does not satisfy the limit (Tolerance 1236) of 10%, set by a user as shown in FIG. 11 and described in step 410 above, an alert for the commodity has been generated and presented to the user.

14. Example User Experience—Presenting Commodity Information for Hedging

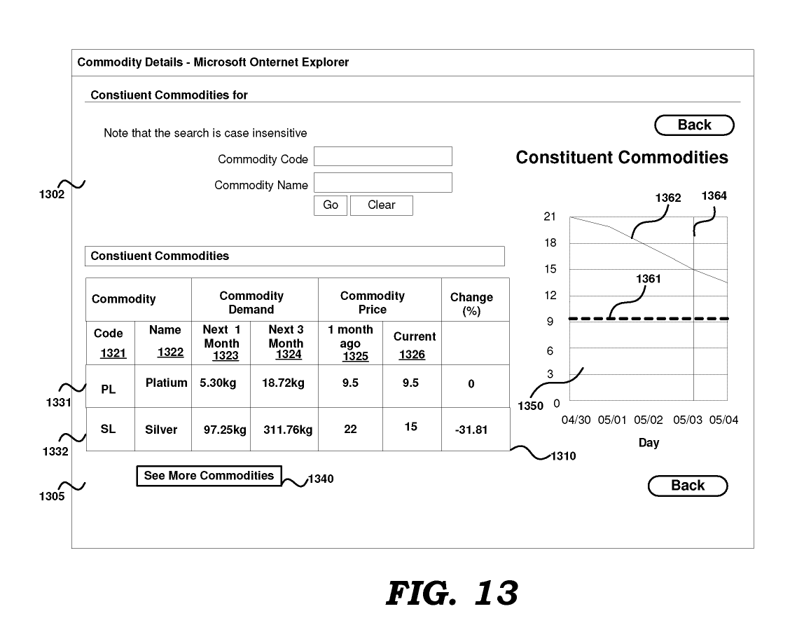

FIG. 13 depicts the manner in which the expected demand and projected prices of commodities of interest may be presented to a user to enable the user to take decisions on hedging of commodities, in one embodiment. A user may use display area 1302 to search for a commodity which needs to be considered for hedging. Display area 1305 shows table 1310 containing multiple rows and columns with each row depicting information related to future aggregate demand for a commodity (for all items together) for specified periods and price information (historical and current) for the respective commodity.

Thus, row 1331 indicates that a commodity with Code (1321) PL and Name (1322) Platinum is expected to have a Next 1 Month (1323) demand of 5.30 Kg and Next 3 Month (1324) demand of 18.72 Kg, with a price 1 month ago (1325) of 9.5 dollars and price current (1326) also of 9.5 dollars. Each demand metric indicates the aggregate demand up to the specific time duration. Thus, demand for 3 months includes demand for 1, 2, and 3 months together. The expected demand may be computed considering the demand from different items, as described in step 730 above.

A user is also presented a graph (1350) of the historical price data and projected price of the commodities of Table 1310. The projected prices of the commodities may be computed as described in step 750 above. The y coordinate represents the price in dollars of a commodity. The x coordinate represents the dates for which the graph is displayed, with a vertical line 1364 showing the current date (05/03 in the example graph shown). The dates to the right of the current date show dates in the future and hence the graphs represent a predicted price of the respective commodity. The price data of Platinum is represented by portion of the graph 1361 and the price data of Silver is represented by portion of the graph 1362. A user may see information about more commodities using See More Commodities (1340).

The information presented in FIG. 13 may enable a user to place hedges for various commodities to mitigate the effects of unfavorable commodity price movements.

It may be appreciated that the features of the present invention are described above with respect to an assembly type manufactured from two components merely for illustration. However the approaches can be extended in the context of more complex assembly types (requiring more than two components or other assembly types) and also to multiple external organizations, without departing from the scope and spirit of the present invention, as will be apparent to one skilled in the relevant arts.

### 15. CONCLUSION

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A machine readable medium storing one or more sequences of instructions for: facilitating a user to use commodity pricing information in making decisions on purchasing of items, said method being implemented in a digital processing system, said method comprising:
receiving an item data indicating a plurality of commodities and a respective plurality of quantities required for manufacturing an item of interest;
receiving automatically a plurality of prices, wherein each of said plurality of prices represents a current price of a corresponding one of said plurality of commodities; and
computing an aggregate commodity cost representing the aggregate cost of said plurality of commodities based on said plurality of quantities and said plurality of prices,
wherein said aggregate commodity cost is used by said user in making purchasing decisions related to said item.

2. The machine readable medium of claim 1, further comprising one or more instructions for:
receiving a limit data indicating a price limit for a first commodity contained in said plurality of commodities;
comparing a first price of said first commodity with said price limit to determine whether said price limit is not satisfied, wherein said first price is contained in said plurality of prices; and
providing an alert to said user if said price limit is not satisfied.

3. The machine readable medium of claim 2, wherein said price limit is at least one of a lower limit and an upper limit.

4. The machine readable medium of claim 1, further comprising one or more instructions for:
receiving a limit data indicating a cost limit for said item;
comparing said aggregate commodity cost with said cost limit to determine whether said cost limit is not satisfied; and
providing an alert to said user if said cost limit is not satisfied.

5. The machine readable medium of claim 4, further comprising one or more instructions for:
receiving a fixed cost information indicating the various fixed costs that are associated with manufacturing of said item; and
comparing a sum of said fixed cost information and said aggregate commodity cost with a price of said item quoted by a supplier,
wherein said user determines to make or buy said item from said supplier based on a result of said comparing.

6. The machine readable medium of claim 1, wherein said plurality of prices for said plurality of commodities are received at a plurality of time instances, said machine readable medium further comprising one or more instructions for:
displaying a corresponding graph associated with each of said plurality of commodities, wherein each graph indicates the price of the corresponding commodity at said plurality of time instances.

7. The machine readable medium of claim 1, wherein said item data further indicates a plurality of items in which a commodity is used, said machine readable medium further comprising one or more instructions for:
determining an aggregate demand in a each of a plurality of future durations for said commodity for all of said plurality of items;
predicting a price of said commodity in each of said plurality of future durations; and
displaying said aggregate demand correlated with said price in said plurality of future durations, thereby simplifying the task of said user in making a decision to hedge said commodity.

8. A computer implemented method of facilitating a user to use commodity pricing information in making decisions on purchasing of items, said method being implemented in a digital processing system, said method comprising:
receiving an item data indicating a plurality of commodities and a respective plurality of quantities required for manufacturing an item of interest;
receiving automatically a plurality of prices, wherein each of said plurality of prices represents a current price of a corresponding one of said plurality of commodities; and
computing an aggregate commodity cost representing the aggregate cost of said plurality of commodities based on said plurality of quantities and said plurality of prices,
wherein said aggregate commodity cost is used by said user in making purchasing decisions related to said item.

9. The method of claim 8, further comprising:
receiving a limit data indicating a price limit for a first commodity contained in said plurality of commodities;
comparing a first price of said first commodity with said price limit to determine whether said price limit is not satisfied, wherein said first price is contained in said plurality of prices; and
providing an alert to said user if said price limit is not satisfied.

10. The method of claim 9, wherein said price limit is at least one of a lower limit and an upper limit.

11. The method of claim 8, further comprising:
receiving a limit data indicating a cost limit for said item;
comparing said aggregate commodity cost with said cost limit to determine whether said cost limit is not satisfied; and
providing an alert to said user if said cost limit is not satisfied.

12. The method of claim 11, further comprising:
receiving a fixed cost information indicating the various fixed costs that are associated with manufacturing of said item; and
comparing a sum of said fixed cost information and said aggregate commodity cost with a price of said item quoted by a supplier,
wherein said user determines to make or buy said item from said supplier based on a result of said comparing.

13. The method of claim 8, wherein said plurality of prices for said plurality of commodities are received at a plurality of time instances, said method further comprising:
displaying a corresponding graph associated with each of said plurality of commodities, wherein each graph indicates the price of the corresponding commodity at said plurality of time instances.

14. The method of claim 8, wherein said item data further indicates a plurality of items in which a commodity is used, said method further comprising:
determining an aggregate demand in a each of a plurality of future durations for said commodity for all of said plurality of items;
predicting a price of said commodity in each of said plurality of future durations; and
displaying said aggregate demand correlated with said price in said plurality of future durations, thereby simplifying the task of said user in making a decision to hedge said commodity.

15. A digital processing system comprising:
a storage storing item data, wherein said item data comprises a plurality of commodities and a respective plurality of quantities required for manufacturing an item;
a network interface to automatically receive a plurality of prices corresponding to said plurality of commodities; and
a processor to compute an aggregate commodity cost representing the aggregate cost of said plurality of commodities based on said plurality of quantities and said plurality of prices;
wherein said aggregate commodity cost is used by said user in making purchasing decisions related to said item.

16. The digital processing system of claim 15, wherein said processor is designed to receive a limit data indicating a price limit for a first commodity contained in said plurality of commodities, said processor is designed to compare a first price of said first commodity with said price limit to determine whether said price limit is not satisfied, wherein said first price is contained in said plurality of prices, and provides an alert to said user if said price limit is not satisfied.
